(19) United States
(12) Patent Application Publication
(10) Pub. No.: US 2022/0313004 A1
(43) Pub. Date: Oct. 6, 2022

(54) METHOD AND APPARATUS FOR BEVERAGE FROTHING

(71) Applicant: Keurig Green Mountain, Inc., Burlington, MA (US)

(72) Inventors: Paul Conroy, Nashua, NH (US); Timothy James MacLean, Wakefield, FL (US); Mario Liuzza, Chelmsford, MA (US)

(73) Assignee: Keurig Green Mountain, Inc., Burlington, MA (US)

(21) Appl. No.: 17/640,205

(22) PCT Filed: Sep. 17, 2020
(86) PCT No.: PCT/US2020/051202

§ 371 Date: Mar. 3, 2022

Related U.S. Application Data
(60) Provisional application No. 62/903,287, filed on Sep. 20, 2019.

(51) Int. Cl. A47J 31/44; A47J 31/52; A47J 31/46

(52) U.S. Cl. CPC A47J 31/4496; A47J 31/4489; A47J 31/5253; A47J 31/461

(57) ABSTRACT

A method and apparatus for frothing a beverage, e.g., using a beverage preparing device and an ejector is described. Within a housing of the beverage preparing device, an air supply and steam supply may be arranged to deliver air and steam to an ejector outside of the housing. Beverage liquid may be frothed by providing steam and air, then steam alone to achieve frothing and heating. An ejector may supply a mixture of steam and air and a controller may be used to regulate the flow of steam and air through the ejector. The ejector may have a venturi that uses steam flow to create a low pressure region, which draws air into the ejector.

### RELATED APPLICATION

This application claims the benefit under 35 U.S.C. § 119(e) of U.S. provisional application No. 62/903,287, filed Sep. 20, 2019. The entire contents of the referenced application are incorporated by reference herein.

### FIELD

Disclosed embodiments are related to frothers and methods for frothing beverages.

### BACKGROUND

The inventions described herein relate to frothing beverages. Systems for frothing beverages are described in a variety of publications, including U.S. Pat. Nos. 7,322,282, 8,962,053, and 9,060,647.

### SUMMARY

In one aspect of the invention, a method of preparing a beverage liquid includes providing steam and air into the beverage liquid while a temperature of the beverage liquid is below a first temperature, providing steam only and no air into the beverage liquid when the temperature of the beverage liquid is at or above the first temperature, but below a second temperature, and stopping steam and air flow into the beverage liquid when the temperature of the beverage liquid is at or above the second temperature. In some cases, the beverage liquid includes milk and providing steam and/or air froths the milk. In one embodiment, the first temperature is 100 degrees F. to 150 degrees F., and the second temperature is 120 degrees F. to 200 degrees F. Steam and/or air may be delivered into an ejector such that steam flow causes air to be drawn into the ejector by a pressure drop caused by steam flow through the ejector. Air flow into the ejector may be stopped by closing an air valve to stop air flow to the ejector, and steam flow may be stopped by closing a valve in a steam supply conduit that is fluidly connected to the ejector. The ejector may include a steam input that receives steam under pressure, and an outlet through which steam and air exit the ejector. The outlet may be immersed in the beverage liquid.

In another aspect of the invention, an apparatus for preparing a beverage liquid includes an ejector with an outlet, a steam inlet, and an air inlet, a steam supply fluidly coupled to the steam inlet, and an air supply fluidly coupled to the air inlet. A controller may be adapted to control the steam supply and the air supply to deliver air and steam to the ejector such that a mixture of air and steam exits the ejector outlet and into the beverage liquid when a temperature of the beverage liquid is below a first temperature, and to control the steam supply and the air supply to deliver only steam to the ejector such only steam exits the ejector outlet when the temperature of the beverage liquid is at or above the first temperature. The ejector may have an elongated housing with the outlet at a distal end of the housing, and the ejector may be located outside of a housing of the apparatus. A steam nozzle of the ejector may be arranged to receive steam under pressure from the steam inlet and emit the steam toward the outlet. Air may be drawn into the air inlet by a venturi or low-pressure vacuum caused by steam emitted from the steam nozzle. The controller may include a sensor to detect the temperature of the beverage liquid, and the controller may control the steam and/or air supply based on a sensed temperature of the liquid. The steam supply may include a steam valve, e.g., inside the apparatus housing, to control a flow of steam to the steam inlet of the ejector, and the controller may be adapted to control the steam valve, e.g., the controller may control a velocity or flow rate of steam and air exiting the outlet of the ejector. Similarly, the air supply may include an air valve, e.g., inside the apparatus housing, to control a flow of air to the ejector, and the controller may be adapted to control the air valve.

In another aspect of the invention, an ejector for frothing a beverage includes a housing with a flow path from a proximal end to a distal end, and an outlet at the distal end to emit steam and/or air. A steam nozzle having a steam inlet and a steam outlet may be arranged to direct steam from the steam outlet into the flow path of the housing at the proximal end, and the steam nozzle may be removably mountable to the proximal end of the steam nozzle. An air inlet at the proximal end of the housing may be arranged to introduce air into the housing flow path at the proximal end. A cap may be removably mounted to the proximal end of the housing over the steam inlet of the steam nozzle, and may have an inlet arranged to attach to a steam supply conduit. The cap may be attached to the housing by one of an interference fit, clearance fit, and transition fit, and may be attached to the housing via the steam nozzle, which may be attached to the housing by one of an interference fit, clearance fit, and transition fit. Thus, the steam nozzle may be removable from the housing by hand and without tools. The steam nozzle may have a flange between the steam inlet and the steam outlet, and the flange may be between the cap and the housing. A gap may be present between the steam outlet of the steam nozzle and near an inlet of a mixing chamber in the flow path of the housing, and air may be drawn into the mixing chamber at the gap. The inlet of the mixing chamber may have a cross sectional size that is larger than a cross sectional size of the steam outlet of the steam nozzle.

In another aspect of the invention, a device for preparing a beverage includes a housing, a steam supply located within the housing and arranged to output steam, a steam conduit fluidly coupled to the steam supply to receive steam and having an outlet end located outside of the housing, an air supply including an air valve located within the housing, and an air conduit fluidly coupled to the air valve and having an outlet end located outside of the housing. An ejector external to the housing may have a steam inlet fluidly coupled to the outlet end of the steam conduit, and an air inlet fluidly coupled to the outlet end of the air conduit, and the ejector may be arranged to mix air and steam and to deliver a mixture of air and steam to froth a beverage. In some cases, the device includes a beverage forming station attached to the housing to dispense a beverage, e.g., the beverage forming station may use a beverage ingredient-containing pod to form a beverage by mixing water with the beverage ingredient. The steam supply may include a thermoblock with a heating element, and a steam valve, e.g., a three way valve with an inlet port attached to the steam source, an outlet port fluidly coupled to the steam conduit, and a vent port. A controller may be arranged to control the steam valve and air valve, and/or other components, such as an air pump of the air supply and/or a pump to deliver water to the steam source.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a process flow of a beverage frothing method in one illustrative embodiment;

FIG. 2 shows a perspective view of a beverage preparing device with an ejector in an illustrative embodiment;

FIG. 3 shows a perspective view of a beverage preparing device with an ejector and a receptacle in an illustrative embodiment;

FIG. 4 shows a schematic view of components of a frothing device or beverage preparing apparatus in an illustrative embodiment; and

FIG. 5 shows a cross-sectional view of an ejector in an illustrative embodiment.

### DETAILED DESCRIPTION

Certain beverages are prepared with froth, which comprises a foam or small bubbles in the beverage liquid. Commonly, milk or other dairy products are frothed for combination with coffee, e.g., to form a cappuccino or latte beverage. Frothing is typically performed with a frothing device that provides air and/or mechanical agitation to the beverage to form froth. Frothing devices may also supply steam to heat the beverage while simultaneously frothing it. In accordance with some aspects of the invention, the inventors have recognized advantages of employing a frothing sequence that delivers air and steam to froth a beverage until the beverage reaches a first temperature, then only delivers steam to the beverage thereafter. In at least some embodiments, the resulting frothing quality is consistent and can be used by untrained people to obtain optimal frothing.

In some embodiments, a frothing device may include an ejector, which can mix air and steam and deliver the mixture of air and steam to a beverage, or can deliver only steam to a beverage liquid. An ejector may be fluidly connected to steam and air sources, and in some cases the air source and/or steam supply may include components contained within a housing of a beverage preparing device while the ejector is positioned external to the housing. For example, an air source may include an air valve to control air flow to the ejector, such that closing the air valve prevents air from entering the ejector, and the air valve may be located within the beverage preparing device housing.

While frothing a beverage, an ejector may be partially immersed in a beverage and may intake some of the beverage into the ejector itself. To facilitate cleaning of the ejector, portions of the ejector can be separated by hand to allow the ejector to be easily cleaned and maintained. Thus, the inventors have recognized advantages of an automated frother with an ejector that can be dismantled by hand and without tools. Such an arrangement permits any user to obtain consistent and high-quality frothed beverages. Furthermore, providing an ejector that can be easily dismantled may simplify cleaning and maintenance of the automated frother.

In some illustrative embodiments below, the beverage that is frothed is milk, cream, a milk alternative, or another dairy-based beverage. In other embodiments, the beverage that is frothed may be something other than milk or other dairy beverage, such as coffee so that frothing forms a crema, like that in an espresso beverage. (As used herein, “beverage” refers to a liquid substance intended for drinking and that may be combined with other materials, or not, prior to consumption. Thus, beverage refers to a liquid that is ready for consumption, e.g., is dispensed into a cup and ready for drinking, as well as a liquid that will undergo other processes or treatments, such as filtering or the addition of flavorings, creamer, sweeteners, another beverage, etc., before being consumed.)

It should be understood that aspects of the invention are described herein with reference to certain illustrative embodiments and the figures. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

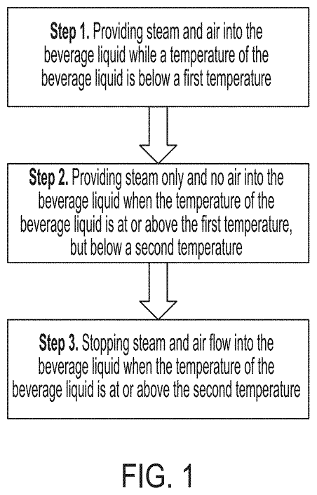

FIG. 1 shows a process flow of an illustrative method for frothing a beverage. In Step 1, steam and air are provided into a beverage liquid while the temperature of the beverage liquid is below a first temperature. For example, if the beverage liquid is milk, milk is often provided for frothing directly out of refrigerated storage. Thus, milk may be provided initially around 40 degrees F., and steam and air may be provided to the milk. Steam and air may be provided into the milk up to a first temperature of the beverage liquid, such as 100 degrees F. to 150 degrees F. In some embodiments, the air and steam may be mixed together by an ejector, which may output the mixed air and steam into the beverage liquid. For example, the ejector may have an outlet that is immersed in the beverage liquid so that the steam and air exit the ejector into the liquid. The air and steam may be delivered to the ejector from an air supply and a steam supply that are fluidly connected to the ejector. In one embodiment, both the air supply and steam supply provide pressurized air and steam, respectively. In another embodiment, the air supply is not pressurized and provides air at ambient pressure to the ejector. To draw ambient air into the ejector, the ejector may include a venturi or similar arrangement that uses steam flow to create a pressure drop within the ejector to draw air into the ejector. After entering the ejector, the air and steam may mix within the ejector to form a homogenous composition, or may be only partially mixed. Other arrangements are possible for mixing air and steam, such as arranging a pair of nozzles side by side such that air and steam emitted by a corresponding one of the nozzles are mixed together while flowing in or upon exiting the nozzle. In another embodiment, air and steam may be mixed together in a tank or other chamber, e.g., by pumping air and steam into a tank. Of course, in some embodiments air and steam need not be mixed at all, and may be provided into a beverage liquid separate from each other.

In Step 2, when the beverage liquid is at or above the first temperature, steam only may be provided to the beverage liquid. For example, while the beverage liquid is at a temperature between a first temperature (e.g., 100 degrees F. to 150 degrees F.) and a second temperature (e.g., 120 degrees F. and 200 degrees F.) air may be prevented from being mixed with steam, and steam only is delivered into the beverage liquid. If air and steam are mixed, air may be prevented from mixing with steam in different ways, depending on the embodiment. In one embodiment, air is prevented from entering an ejector by closing an air valve or air inlet that is connected to the ejector. For example, the air valve may be part of an air supply that includes an air pump or reservoir of pressurized air, and the air valve may be closed to stop flow of air for mixing with steam. In other embodiments, operation of an air pump used to deliver air for mixing with steam may be stopped, thereby terminating air flow with or without the use of an air valve. In another embodiment, the air supply may be closed off using a cap, a plug, or other suitable stopping mechanism. In yet other embodiment, an air inlet opening of an ejector may be blocked or occluded by beverage liquid, which prevents air from being drawn into the ejector. Without air provided for mixing with steam, only steam is delivered to the beverage liquid.

The determination of the beverage liquid temperature to control air and steam flow may be done in different ways. For example, a user may place a thermometer in the beverage liquid and press a button on a beverage preparing machine to indicate that the first temperature and/or a second temperature discussed below has been reached. In response to depression of a button indicating the beverage liquid has reached the first temperature, the control circuit of a beverage preparing machine may close an air valve or otherwise stop air flow while continuing to provide steam to the beverage liquid. Alternately, the user may close an air valve to terminate air supply for mixing with steam when the beverage liquid reaches the first temperature, e.g., by viewing a thermometer in the beverage liquid. In another embodiment, the beverage machine may detect a temperature of the beverage liquid, and control an air supply and steam supply accordingly. To detect the temperature of the beverage liquid, the beverage machine (or user) can employ a thermometer, thermocouple, infrared or other suitable temperature sensor. With a contact-type sensor such as a thermometer or thermocouple, the sensor may be in direct contact with the beverage liquid, or in indirect contact, e.g., via a wall of a container holding the liquid. Thus, the beverage liquid temperature may be detected by measuring the beverage liquid directly with a temperature sensor in direct contact with the beverage liquid, or indirectly with a temperature sensor coupled to a surface in contact with the beverage, like a receptacle. Alternatively, a temperature sensor may not be needed to determine a temperature of the beverage liquid, and instead the temperature may be determined by the controller by inference or otherwise indirectly determined. For example, given the air and steam temperature, known air and steam flow rates, and/or the starting beverage temperature, the temperature of the beverage may be determined based on an amount of the time that air and steam are introduced to the beverage liquid. For example, where the beverage liquid is milk, the milk provided may be initially at or around a temperature of 40 degrees F., and the beverage machine control system may be programmed to determine that the milk is at a first temperature (such as 100 degrees F.) after air and steam are delivered to the milk for a first period of time. In other embodiments, a sound or pitch of the air and steam entering the beverage liquid may be used to indirectly determine temperature. In such a case, the beverage machine may include a microphone or other sensor to detect sound emanating from the beverage liquid during air and steam introduction, and determine that the liquid is at a first temperature based on a frequency and/or amplitude of detected sound.

In Step 3, steam and air flow are stopped when the beverage liquid is at or above a second temperature that is higher than the first temperature. In one embodiment, the steam supply includes a steam valve, which may be closed to stop the flow of steam to the beverage liquid. A user may close the steam valve manually, or a controller may close the steam valve, e.g., in response to automatically detecting the beverage liquid temperature is at or above the second temperature or in response to a user pressing a button. In other embodiments, a steam generator may be controlled to stop the production of steam, such as by interrupting electrical power to the steam generator, and/or stopping a supply of water to the steam generator. In other arrangements, a conduit that carries steam to an ejector or other outlet that provides steam to the beverage liquid may be vented to atmosphere, thereby stopping flow of steam to the beverage liquid. With the stopping of steam introduction to the beverage liquid, the frothing operation may be complete, or other frothing operations may be performed, such as mechanical whipping. The beverage liquid may be consumed after steam flow is stopped, or other processes may be performed, such as mixing the frothed beverage liquid with other beverage components, such as mixing with a coffee beverage. The beverage liquid temperature with respect to the second temperature may be determined as discussed above, e.g., by a user observing a thermometer, by a controller detecting the temperature using a temperature sensor, by a controller or user inferring the beverage temperature by sound, touch, time of delivering steam to the beverage liquid and others.

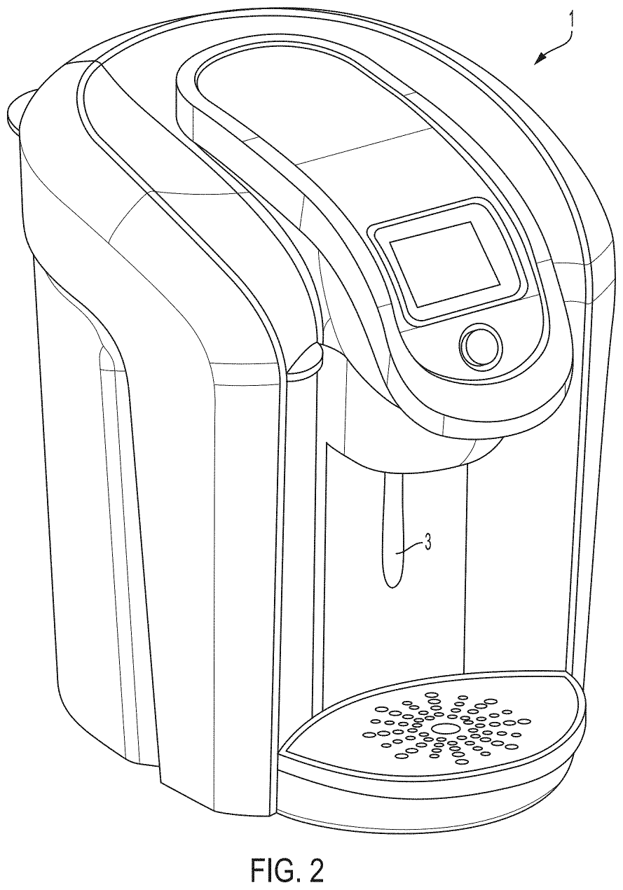

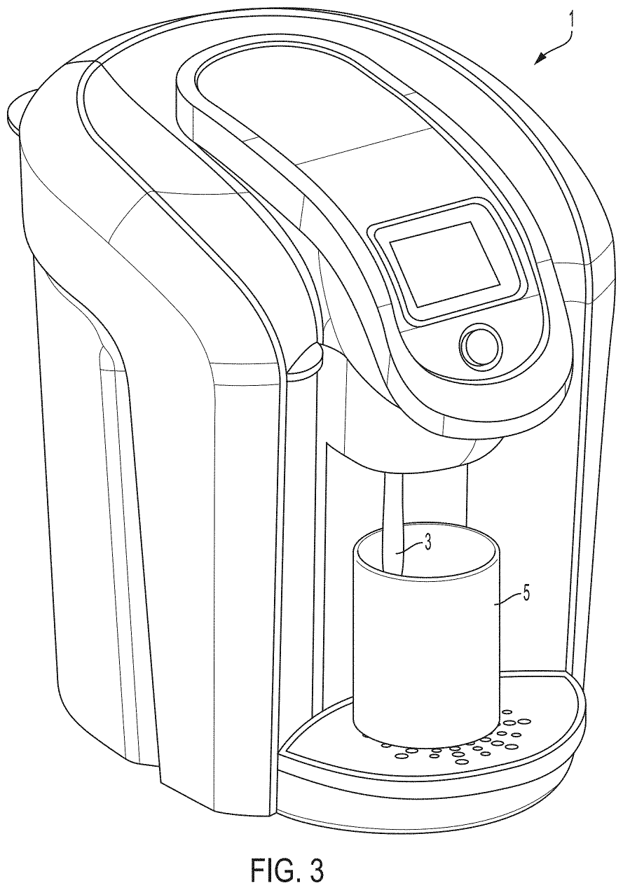

The method shown in FIG. 1 may be performed by a beverage preparing device as shown in FIGS. 2-4. In the illustrative embodiment of FIGS. 2-4, the beverage preparing device is depicted with an apparatus housing 1 and an ejector 3 external to the housing 1. A receptacle 5, such as a user's cup, may contain a beverage to be frothed and the ejector 3 or other steam and/or air outlet may extend into the receptacle 5 and be partially immersed in the beverage. The beverage preparing device may further comprise a beverage forming station attached to the housing 1 to dispense a beverage. In one embodiment, the beverage forming station includes a brew chamber to hold a beverage ingredient, e.g., ground coffee in a cartridge, used to form the beverage by mixing the beverage ingredient with a liquid. Although the beverage preparing device may be used to form any suitable beverage, such as tea, coffee, other infusion-type beverages, beverages formed from a liquid or powdered concentrate, soups, juices or other beverages made from dried materials, in this illustrative embodiment the device is arranged to form coffee or tea beverages.

In one embodiment, the housing 1 of the beverage preparing device encloses components to deliver steam and air to the ejector 3 or other steam and air outlet(s). In this embodiment, the ejector 3 includes a steam inlet that is fluidly coupled to the outlet end of a steam supply conduit 13 and an air inlet fluidly coupled to the outlet end of an air supply conduit 17. Thus, the ejector steam inlet and air inlet are fluidly coupled to a steam supply 7 and an air supply 15. The ejector 3 may be arranged to mix air and steam and to deliver a mixture of air and steam to froth the beverage in the receptacle 5. Steam may be delivered by the steam supply 7, which may include a steam generator, such as a thermoblock 23, tank or other boiler with a heating element to heat water and generate steam. In this embodiment, the steam supply 7 is located within the housing 1 and receives water from a water supply 25. For example, water from the water supply 25 may be delivered to the thermoblock 23 by a pump 27, which could be a diaphragm pump, a piston pump, a gravity pump, or other suitable type of pump. As is known in the art, the thermoblock 23 may employ an electrical resistance heater to vaporize water provided at an inlet to the thermoblock 23 by the pump 27 and output steam to an output 11 of the heater block 23. The steam output 11 of the thermoblock 23 may be fluidly coupled to a first inlet port of a steam valve 9. In one embodiment, the steam valve 9 comprises a three-way solenoid valve that has a second vent port open to ambient (e.g., to an exhaust), which allows steam to be safely vented from the thermoblock 23 and the steam supply conduit 13. The third outlet port of the steam valve 9 may be fluidly coupled to the steam supply conduit 13 and thus the steam inlet of the ejector. The outlet end of the steam conduit 13 may be positioned outside of the housing 1. The thermoblock 23 may output steam to the steam inlet at a maximum output pressure at 4 psi (at zero flow rate), and have a normal operating pressure of 2.5 psi at a flow rate of about 5-6 ml/sec, e.g., 5.4 ml/sec.

The housing 1 may also enclose an air supply 15, which may comprise a source of pressurized air, such as an air pump or pressurized tank, or may provide unpressurized, e.g., ambient, air. The air supply 15 may be fluidly coupled to an air valve 19, which may have a first inlet port fluidly coupled to receive pressurized or unpressurized air and a second outlet port connected to the air supply conduit 17 and thus the air inlet of the ejector 3. That is, the air valve 19 can control air flow to the air inlet of the ejector 3. In one embodiment, the outlet end of the air supply conduit 17 may be located outside of the housing 1, e.g., at a location coupled to the ejector 3. In one embodiment where the air supply 15 includes an air pump, the air supply 15 has a maximum output pressure at 4 psi (at zero flow rate when the air valve 19 is closed), and a normal operating pressure of 2.5 psi at a flow rate of about 5-6 ml/sec, e.g., 5.4 ml/sec.

To froth a beverage using the beverage preparing device of FIGS. 2-4, a user may provide a container 5, e.g., including milk or other liquid to be frothed, or the beverage preparing device may dispense a liquid, such as dairy beverage, coffee, mixtures of different beverage components, etc. into a container 5. Frothing may be performed manually or automatically, or a combination of manually and automatically, e.g., where a user provides input to the beverage preparing device and the device performs portions of the frothing process under automatic control. For example, to start frothing, the user may actuate a switch, a button, a dial, or another suitable control mechanism on the beverage preparing device, and in response the beverage preparing device may begin a flow of steam and air to the ejector 3, etc. In manual control, the user may modulate steam and air flow into the beverage by controlling the air and steam valves, e.g., depending on the conditions of the beverage, such as froth level, temperature, and froth bubble size. During frothing, the user may move the receptacle 5 with respect to the ejector 3 to expose different portions of the beverage to steam and/or air flow, or the receptacle 5 may remain stationary.

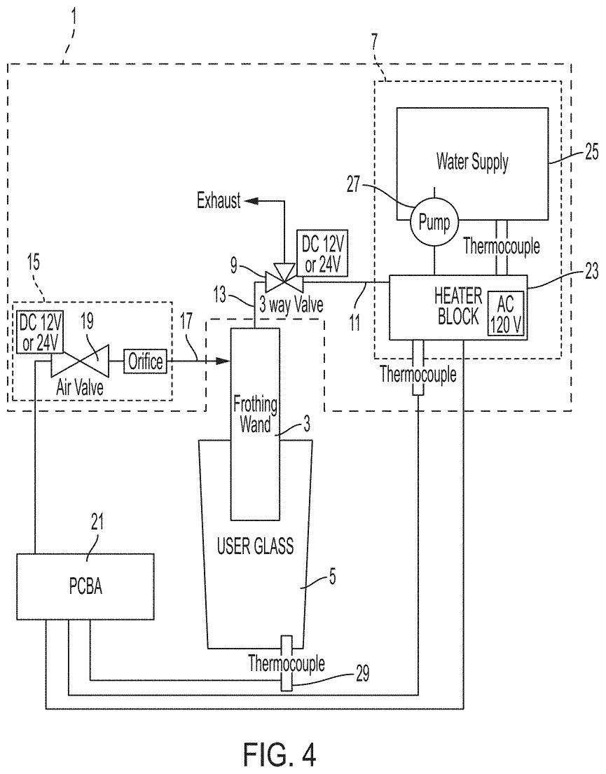

In an embodiment where frothing is performed automatically, the beverage preparing device may be controlled by a controller 21 to perform the steps of the method described above in FIG. 1. The controller 21 may be coupled to various components to detect and control conditions for regulating fluid flow, as shown in the schematic block diagram of FIG. 4. For example, the controller 21 may be arranged to control the steam valve 9 and the air valve 19. Although the depicted embodiment shows the controller 21 external to the housing 1, the controller 21 may be positioned within the housing in other embodiments. The controller 21 may comprise a suitably programmed data processing device, or another suitable analog and/or digital control system. In one embodiment, the controller 21 is linked to at least one of the components of the steam supply 7 and air supply 15, which are controlled by the controller 21 to achieve frothing.

When the user activates the beverage preparing device to initiate a frothing operation (such as by interacting with a user interface included as part of the controller 21), the controller 21 may turn on the heater block 23, which may include a temperature sensor that allows the controller 21 to monitor the temperature of the heater block 23. The controller 21 may control the pump 27 to pump water from the water supply 25 to the heater block 23, which heats the water to form steam, which is delivered through the thermoblock outlet 11 to the first port of the steam valve 9. Initially, the steam valve 9 may be configured to vent any steam to the second exhaust port. When the controller 21 detects a consistent flow of steam, the controller 21 may control the steam valve 9 to allow steam to flow through the valve 9 to the third port coupled to the steam supply conduit 13, which is fluidly coupled to the steam inlet of the ejector 3 positioned outside the housing 1.

When the steam begins to flow to the ejector 3, the controller 21 may configure the air valve 19 to deliver air through the air supply conduit 17 and into the air inlet of the ejector 3 as well. In some embodiments, the ejector 3 comprises a venturi and air is delivered by flowing steam through the ejector 3 to create a low-pressure vacuum that draws air in through the air inlet via the air supply conduit 17. Alternately, air may be provided via the air supply conduit 17 at some positive pressure, e.g., a normal operating pressure of 2.5 psi at a flow rate of 5-6 ml/sec. Within the ejector 3, the air and steam may mix and be delivered into the beverage through an outlet of the ejector 3. In one embodiment, the outlet of the ejector 3 is immersed in the beverage liquid, where the outlet is positioned at a distal end of the ejector 3.

As the beverage heats and froths from the mixture of air and steam, the controller 21 may monitor the beverage temperature through a temperature sensor 29 that is directly or indirectly coupled to the beverage liquid. When the controller 21 detects the temperature of the beverage liquid is at or above a first temperature, the controller may configure the air valve 19 to stop air flow into the air supply conduit 17 while continuing steam flow to the ejector 3. The venturi may not draw air into the ejector when the air valve 19 is closed because the air inlet of the ejector 3 is effectively closed. When the controller 21 detects the beverage is at or above a second temperature greater than the first temperature, the controller 21 may stop steam flow into the ejector 3. In one embodiment, the controller 21 configures the steam valve 9 to route steam from the steam supply conduit 11 to the second exhaust port to stop steam flow to the ejector 3. In another embodiment, the controller shuts off the heater block 23 and the pump 27 to stop steam production.

Although the controller 21 has been described as detecting temperature, parameters such as fluid flow rate, pressure, temperature, and volume of air and/or steam may also be measured and controlled by the controller 21. Furthermore, the controller 21 may also compare the parameters and status of different components to direct fluid flow. For example, the controller may detect that the beverage temperature is higher than desired and may partially or fully close the steam valve 9 to prevent steam from being applied to the beverage and further increasing the temperature. Alternately, the thermoblock heating element may be controlled to reduce the temperature, pressure and/or flow rate of steam produced. In one embodiment, the controller controls the air and steam valves but does not control the ejector 3. In other embodiments, the controller controls the air and steam valves as well as the ejector 3, or only controls the ejector 3. The ejector may comprise multiple components that can be controlled by the controller. These components may include, but are not limited to, a valve at the outlet of the ejector, at the steam inlet, and/or air inlet to the ejector. Those of skill in the art will appreciate that the beverage preparing device may be configured in a variety of different ways, and thus aspects of the invention should not be narrowly interpreted as relating only to one type of beverage preparing device.

The controller 21 may be coupled to at least one of the ejector, beverage, or receptacle to detect a temperature, the size of froth bubbles, a time interval of flow, or another relevant condition. In response to a predetermined condition, the controller may control the steam supply and the air supply to regulate the velocity of steam and air. In one configuration, the controller allows steam and air into the ejector 3, such that a mixture of air and steam exits the ejector through the outlet and into the beverage when a temperature of the beverage liquid is below a first temperature. In another embodiment, the controller controls the steam supply and air supply to deliver only steam to the ejector 3 when the temperature of the beverage is at or above the first temperature. By regulating the steam supply and air supply, the controller may also control the velocity and/or flow rate of the steam and air. The controller may sense the temperature of the beverage with one of a thermocouple, infrared radiation, thermostat, and thermistor.

In accordance with an aspect of the invention, the ejector 3 is arranged external to the housing 1. The air and steam mix within the ejector 3 before exiting the ejector 3 through an outlet at a distal end of the ejector 3. The outlet may be positioned within a receptacle 5 containing a beverage, such that the outlet is immersed in the beverage. The mixture of air and steam exiting the outlet may cause the beverage to heat and froth. To monitor the beverage temperature, a temperature sensor may be coupled to the beverage. In one embodiment, the temperature sensor is mounted on an exterior surface of the receptacle 5 such that the beverage temperature is indirectly measured, such as through infrared. In another embodiment, the temperature sensor is directly coupled to the beverage, such near the outlet of the ejector 3 or within the receptacle 5. When certain beverage temperatures are detected, fluid flow into the beverage may be modified. For example, a preselected temperature may cause air flow to stop while steam flow continues, or a different preselected temperature may cause air flow and steam flow to stop.

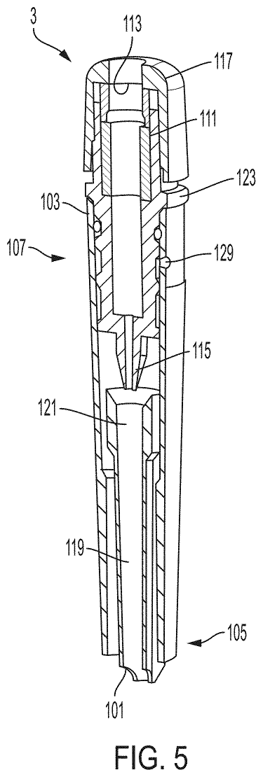

To facilitate maintenance of the beverage preparing device of FIGS. 2-4, the ejector 3 may be configured as multiple pieces that can be separated by hand and without tools. In the illustrated embodiment shown in FIG. 5, the ejector 3 comprises an elongated housing 103 with a distal end 105 and proximal end 107. The elongated housing 103 has an outlet 101 at the distal end 105 of the housing, and the outlet 101 may be immersed in the beverage during beverage frothing. In one embodiment, the elongated housing 103 is substantially hollow throughout, such that a flow path extends from the proximal end 107 to the distal end 105 of the elongated housing 103. At the proximal end 107 of the elongated housing 103, a steam nozzle 111 may be removably retained within the elongated housing 103, e.g., by inserting the distal end of the steam nozzle 111 into the elongated housing 103. Removing the steam nozzle 111 from the elongated housing 103 may facilitate cleaning of the elongated housing 103 and the steam nozzle 111, as the user may gain access to hard-to-reach and small crevices. In one embodiment, the steam nozzle 111 has a flange 123 between the distal and proximal ends of the nozzle 111 that may act as a stop to insertion of the nozzle 111 into the housing 103. In one embodiment, the steam nozzle 111 is attached to the elongated housing 103 by one of an interference fit, clearance fit, transition fit, or other suitable attachment method. A removable cap 117 may be attached to the elongated housing 103 via the steam nozzle 111. That is, the cap 117 may be fitted over the proximal end of the nozzle 111 and engage with the nozzle 111 by an interference fit, screw thread or other engagement. The inlet 113 of the steam nozzle 111 may pass through the cap 117 to allow fluid (e.g., steam) into the nozzle 111.

The steam nozzle 111 may include a steam nozzle outlet 115 opposite the steam nozzle inlet 113. Like the elongated housing 103, the steam nozzle 111 is substantially hollow throughout and comprises a non-uniform cross section. Between the distal end 105 and proximal end 107 of the elongated housing 103, an air inlet 129 may fluidly couple to the air supply conduit 17 (not shown). In one embodiment, the steam nozzle inlet 113 is coupled to the steam conduit 13, which is fluidly coupled to the steam supply to receive steam. A distal end of the steam nozzle 111 may extend toward a distal end 105 of the elongated housing 103, and a mixing chamber 119 may be positioned between the steam nozzle outlet 115 and the distal end 105 of the elongated housing 103. The mixing chamber 119 may extend distally toward the distal end of 105 of the elongated housing 103, where an outlet 101 allows fluid to exit the ejector 3. The outlet 101 may be suitably sized so that the ejector 3 is capable of delivering air and steam at a suitable flow rate and pressure to froth and heat the beverage. In some embodiments, the outlet 101 has a size of 0.25 mm. Thus, the outlet 101 may continuously vent the contents of the ejector 3 at a suitable pressure and flow rate to move liquid to the receptacle 5. In some embodiments, a volume of liquid of about 250 ml may be moved to the receptacle 5 in about 45-60 seconds.

As is known in the art, a distal cross-section of the steam nozzle 111 is narrower than a proximal cross-section of the steam nozzle 111. The air inlet 129 may supply air into a space between the steam nozzle 111 and the housing 103 so that the air may enter into the mixing chamber 119 at a gap between the steam nozzle outlet 115 and the inlet of the mixing chamber 119. In one embodiment, the steam nozzle 111 is arranged to receive steam from a steam supply through the steam nozzle inlet 113. As high velocity steam exits the nozzle outlet 115, a pressure drop is created which draws air into the gap between the nozzle outlet 115 and the mixing chamber 119. The air and steam mix in the gap and in the mixing chamber 119. The mixture of air and steam may exit the outlet 101, e.g., for introduction into a beverage liquid. If the air inlet 129 is closed, steam only may flow from the steam nozzle outlet 115 to the outlet 101. For ease of maintenance, the cap 117 and the steam nozzle 111 may be removed from the housing 103 of the ejector 3 by hand to allow access for cleaning. In some embodiments, one or more components of the ejector 3 may be machine washed. The mixing chamber 119 may also be removable from the elongated housing 103 to aid in cleaning.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method of preparing a beverage liquid, comprising:
providing steam and air into the beverage liquid while a temperature of the beverage liquid is below a first temperature;
providing steam only and no air into the beverage liquid when the temperature of the beverage liquid is at or above the first temperature, but below a second temperature; and
stopping steam and air flow into the beverage liquid when the temperature of the beverage liquid is at or above the second temperature.

2. The method of claim 1, wherein the beverage liquid includes milk and the steps of providing steam and air and providing steam only froths the milk.

3. The method of claim 1, wherein the first temperature is 100 degrees F. to 150 degrees F.

4. The method of claim 1, wherein the second temperature is 120 degrees F. to 200 degrees F.

5. The method of claim 1, wherein the step of providing steam and air includes delivering steam into an ejector such that air is drawn into the ejector by a pressure drop caused by steam flow through the ejector.

6. The method of claim 5, wherein the step of providing steam only includes closing an air valve to stop air flow to the ejector.

7. The method of claim 5, wherein the step of stopping steam and air flow includes closing a valve in a steam supply conduit that is fluidly connected to the ejector.

8. The method of claim 5, wherein the ejector includes a steam input that receives steam under pressure, and an outlet through which steam and air exit the ejector, wherein the outlet is immersed in the beverage liquid.

9. An apparatus for preparing a beverage liquid, comprising:
an ejector with an outlet, a steam inlet, and an air inlet;
a steam supply fluidly coupled to the steam inlet;
an air supply fluidly coupled to the air inlet; and
a controller adapted to control the steam supply and the air supply to deliver air and steam to the ejector such that a mixture of air and steam exits the ejector outlet and into the beverage liquid when a temperature of the beverage liquid is below a first temperature, and to control the steam supply and the air supply to deliver only steam to the ejector such only steam exits the ejector outlet when the temperature of the beverage liquid is at or above the first temperature.

10. The apparatus of claim 9, wherein the ejector has an elongated housing with the outlet at a distal end of the housing.

11. The apparatus of claim 9, wherein the ejector includes a steam nozzle arranged to receive steam under pressure from the steam inlet and emit the steam toward the outlet.

12. The apparatus of claim 11, wherein air is drawn into the air inlet by a venturi or low-pressure vacuum caused by steam emitted from the steam nozzle.

13. The apparatus of claim 9, wherein the controller includes a sensor to detect the temperature of the beverage liquid.

14. The apparatus of claim 9, wherein the steam supply includes a steam valve to control a flow of steam to the steam inlet of the ejector, and wherein the controller is adapted to control the steam valve.

15. The apparatus of claim 9, wherein the controller is adapted to control a velocity or flow rate of steam and air exiting the outlet of the ejector.

16. The apparatus of claim 9, wherein the air supply includes an air valve to control a flow of air to the ejector, and wherein the controller is adapted to control the air valve.

17. The apparatus of claim 13, wherein the steam supply includes a steam valve to control steam flow to the steam inlet of the ejector and the air supply includes an air valve to control air flow to the air inlet of the ejector, the apparatus further comprising an apparatus housing in which the steam valve and air valve are located, the ejector being located outside of the apparatus housing.

18. An ejector for frothing a beverage, comprising:
a housing with a flow path from a proximal end to a distal end, the housing having an outlet at the distal end to emit steam and/or air;
a steam nozzle having a steam inlet and a steam outlet, the steam nozzle arranged to direct steam from the steam outlet into the flow path of the housing at the proximal end, the steam nozzle being removably mountable to the proximal end of the steam nozzle;
an air inlet at the proximal end of the housing arranged to introduce air into the housing flow path at the proximal end; and
a cap removably mounted to the proximal end of the housing over the steam inlet of the steam nozzle.

19-22. (canceled)

23. The ejector of claim 18, wherein a gap is present between the steam outlet of the steam nozzle and an inlet of a mixing chamber in the flow path of the housing, wherein air is drawn into the mixing chamber at the gap.

24-32. (canceled)

33. A device for preparing a beverage, comprising:
a housing;
a steam supply located within the housing and arranged to output steam;
a steam conduit fluidly coupled to the steam supply to receive steam and having an outlet end located outside of the housing;
an air supply including an air valve located within the housing;
an air conduit fluidly coupled to the air valve and having an outlet end located outside of the housing; and
an ejector external to the housing having a steam inlet fluidly coupled to the outlet end of the steam conduit, and an air inlet fluidly coupled to the outlet end of the air conduit, the ejector arranged to mix air and steam and to deliver a mixture of air and steam to froth a beverage.

34-42. (canceled)
